(19) United States
(12) Patent Application Publication
(10) Pub. No.: US 2026/0289481 A1
(43) Pub. Date: Sep. 24, 2026

(54) METHOD FOR REDUCING CARGO THEFTS

(71) Applicant: ZF CV SYSTEMS GLOBAL GMBH, Bern (CH)

(72) Inventor: Arunmozhi RJAVEL, Cuddalore (IN)

(21) Appl. No.: 19/475,436

(22) PCT Filed: Apr. 3, 2024
(86) PCT No.: PCT/EP2024/059024

§ 371 Date: Oct. 15, 2025

(30) Foreign Application Priority Data
Apr. 17, 2023 (IN) 202311027998

(51) Int. Cl. G06Q 10/0832; G06Q 10/0833

(52) U.S. Cl. CPC G06Q 10/0832; G06Q 10/0833

(57) ABSTRACT

A method for reducing thefts of cargo from commercial vehicles, including anonymizing cargo related data being used in a cargo and/or fleet management system is anonymized at least at several access levels in which the cargo related data is displayed to a user. The anonymizing of the cargo related data can include masking of the cargo related data, including at least cargo type, cargo details, customer details, entire route from start to destination, and/or destination of the cargo.

### CROSS REFERENCE TO RELATED APPLICATIONS

This application is a U.S. National Phase application under 35 U.S.C. § 371 of International Application No. PCT/EP2024/059024, filed on Apr. 3, 2024, and claims benefit to Indian Patent Application No. IN 202311027998, filed on Apr. 17, 2023. The International Application was published in English on Oct. 24, 2024 as WO 2024/217868 A1 under PCT Article 21(2).

### FIELD

The present disclosure relates to methods and systems for reducing cargo theft.

### BACKGROUND

Cargo movement has increased globally across the world due to increasing online purchases. Along with this fact, there is significant increase in cargo thefts as well, which amount to loss in billions of dollars globally every year. More than half of these thefts happen due to insider information and remain untraceable due to lack of proper evidence.

Methods and systems have been shown to monitor and provide information in a secure way. For example, international patent application WO 97/13208A1 discloses an electronic vehicle log system, which is introduced to replace a manually written log. This electronic vehicle log system provides secure access to data saved on a non-volatile memory by authorized persons.

Patent application CN 110298576A discloses a system for verifying of dispatching a good to a designated addressee. In this process, encryption of dispatch information is done in order to verify the delivery of the good to the correct addressee.

However, there is still a problem of providing a proper method for preventing cargo theft. Hence, a new approach is needed in order to prevent cargo theft.

### SUMMARY

In an embodiment, the present disclosure provides a method for reducing thefts of cargo from commercial vehicles, comprising anonymizing cargo related data being used in a cargo and/or fleet management system is anonymized at least at several access levels in which the cargo related data is displayed to a user.

### BRIEF DESCRIPTION OF THE DRAWINGS

Subject matter of the present disclosure will be described in even greater detail below based on the exemplary figures. All features described and/or illustrated herein can be used alone or combined in different combinations. The features and advantages of various embodiments will become apparent by reading the following detailed description with reference to the attached drawings, which illustrate the following:

FIG. 1 illustrates a flow diagram of a method according to an embodiment of the present disclosure;

FIG. 2 illustrates a flow diagram for route anonymization according to an embodiment of the present disclosure; and

FIG. 3 illustrates a diagram for masking a number plate according to an embodiment of the present disclosure.

### DETAILED DESCRIPTION

In an embodiment, the present disclosure provides a method for reducing thefts of cargo from commercial vehicles, wherein cargo related data being used in a cargo and/or fleet management system is anonymized at least at several access levels in which cargo related data is displayed to a user.

In an embodiment, anonymizing of cargo related data includes masking of cargo related data, including at least cargo type, and/or cargo details and/or customer details and/or entire route from start to destination and/or the destination of the cargo.

In an embodiment, masking of entire route and/or masking of destination of cargo includes providing checkpoints for each cargo route such that only a predefined part of the route is displayed at a time, and only after reaching a checkpoint, the next checkpoint is revealed.

In an embodiment, one checkpoint is the destination, which is only revealed a predefined amount of checkpoints ahead of the destination, or which is the last checkpoint.

In an embodiment, cargo related data being used in a cargo and/or fleet management system is traced at least at several levels of access.

In an embodiment, tracing information of access and display of cargo related data includes at least tracing each access to cargo related data in predefined time steps, and/or restricting access to cargo related data, and/or encrypting data transfers within the cargo and/or fleet management system.

In an embodiment, media captures and data export are disabled.

In an embodiment, periodic testing is done by system wide tests, which aim at extracting cargo related data from the cargo and/or fleet management system, which should be excluded from being extracted, in order to find a system gap.

Further provided is a computer program product comprising instructions, which, when the program is executed by one or more processing units, cause the one or more processing units to carry out the method.

For a more complete understanding of embodiments of the present disclosure, embodiments will now be described in detail with reference to the accompanying drawings. The detailed description will illustrate and describe preferred embodiments of the present disclosure. It should of course be understood that various modifications and changes in form or detail could readily be made without departing from the spirit of the present disclosure. It is therefore intended that the present disclosure not be limited to the exact form and detail shown and described herein. Further, the features described in the description and the drawings disclosing the embodiments of the present disclosure can be considered alone or in combination.

While the present disclosure is subject to various modifications and alternative forms, embodiments thereof have been shown by way of example in the drawings and will herein be described in detail. The present disclosure should be understood to not be limited to the particular forms disclosed, but on the contrary, to cover all modifications, equivalents, and alternatives falling within the spirit and scope of the present disclosure.

An embodiment of the present disclosure is specifically directed to commercial vehicles (in the following only named vehicle) for cargo transport and the reduction of thefts of cargo from those vehicles.

As initially mentioned, due to the increasing online purchases, also cargo movement is increasing. Following this trend, also cargo theft is increasing, which in most cases cannot be traced, but which is most likely done by insiders in a lot of cases.

In order to reduce cargo theft, the following method is provided. This method can be implemented as an add-on on present cargo and/or fleet management systems 100. It can also be an integral part of new cargo and/or fleet management systems 100.

Such cargo and/or fleet management systems 100 are systems that are used to monitor, track, and create detailed performance reports on vehicle fleets. A fleet management system is used to create more efficient driving routes, track vehicle inventory, and provide cost management and analysis, as well as track driver performance. Fleet management tools include mobile components to support on-the-go updates and communications surrounding changes, enabling managers and fleet employees to work together for maximum efficiency in delivery operations.

Cargo and/or fleet management systems 100 also provide cargo related data 200 to users. Such data is cargo type and/or other cargo related information such as amount, value etc. Also, route related information including trip data is stored in a cargo and/or fleet management system 100, such as predefined waypoints for e.g. loading/unloading, as well as e.g. navigation information.

At the moment, cargo related data 200 can be accessed by e.g. the driver 301 of the vehicle, a dispatcher 302, developers, maintenance personnel, supervisors 303 and other authorized persons. The access can be restricted such that e.g. a password is needed. This wide range of authorized persons is needed, because all those people have an interest in accessing the data for various purposes such as getting information about the route/destination for delivering the cargo from a start point to an end point, or to maintain the system etc.

However, since access to all data is allowed for authorized persons, the risk of misuse is increasing. Since it is not necessary to provide all information for most purposes, the following method has been provided in order to reduce misuse and thus cargo theft.

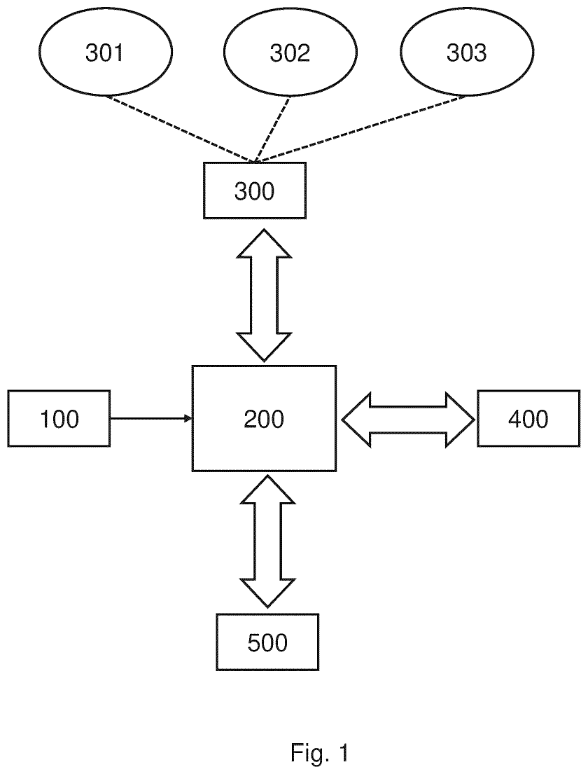

In an aspect, the provided method can anonymize cargo related data 200 at least at several access levels (levels having defined access rights for dedicated users) where cargo related data 200 is displayed to a user. The step of anonymization of data is indicated with reference numeral 300 in the flow chart shown in FIG. 1. The anonymization of cargo related data 200 is preferably done in every level of the logistics orchestration system resp. fleet management system, in which cargo related data 200 is displayed, so that cargo type, route and other relevant cargo related data 200 cannot be leaked to outside the system and thus to e.g., thieves. Examples for access levels are different kinds of users such as a supervisor (highest level, having access to most information), a dispatcher, a driver, a recipient at destination (lowest level).

Anonymization 300 of cargo related data 200 means that route related information and also cargo related data including cargo type are masked so that this information cannot be easily accessed by e.g. drivers 301, supervisors 303, dispatchers 302 or other people. Specifically, cargo details are masked, i.e. which type of cargo is to be delivered. Also, customer details are masked, so that no conclusions can be drawn to the goods of the cargo by knowing the customer. The same applies to the end stop (destination), which can also be masked in order not to be able to draw conclusions to the customer or the goods, and also to mask the possible route to the destination.

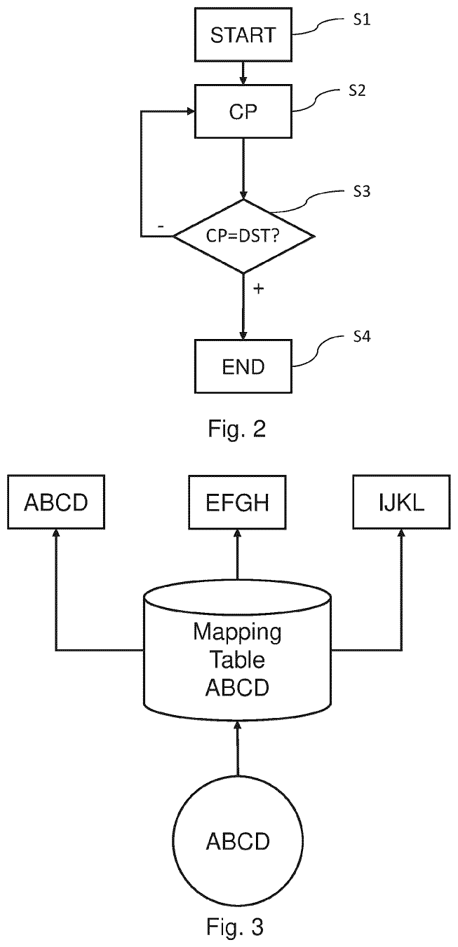

FIG. 2 shows a flow chart of masking part of the route to a destination (END in FIG. 2). The destination is preferably known by the driver, but can also be masked in one embodiment. When starting the trip (step S1 in FIG. 2), only one or more next checkpoints CP are shown to the driver in step S2. For example, only two upcoming checkpoints CP can be shown. After reaching one checkpoint, in step S3 it is checked whether the reached checkpoint CP is the destination. If not, the program branches back to step S2 where the next checkpoint CP is displayed. If it is determined that the last checkpoint CP is the destination, it is indicated that the trip has ended (step S4 in FIG. 2). As a matter of course, the indication of the end of the trip can also be displayed to the driver one or two checkpoints CP ahead of the final stop (destination), so that the driver is able to prepare for shortly reaching the destination (END in FIG. 2).

Anonymization of the route has the effect that due to non-showing of the whole route, it becomes much more difficult to leak the route e.g. by a driver to thieves. Hence, capturing the vehicle and thus the cargo or to plan a theft becomes much more unlikely. At the same time of providing only a part of the route data, enough data can be provided to the driver in order not to affect his/her work. For example, enough data, i.e. checkpoints CP, need to be provided in order that the driver can plan his/her breaks for sleeping, fueling etc. The process of data anonymization is sometimes also called “record curtaining” in which some of the data is displayed clear whereas other data is masked or hidden.

In an embodiment, masking of data can be done by e.g. masking the number plate of the entity, e.g. a truck, by using a mapping table, as shown in FIG. 3. For example, the number plate of a truck is “ABCD”, this information is masked by the mapping table such that the driver is provided with the information “ABCD”, since he can see the number plate by looking at it. A cargo team as well as a dispatcher cannot see the number plate and are provided with the masked information, only. That means that the cargo team will e.g. be provided with information that the number plate of the truck is “EFGH” and the dispatcher will be provided with information that the number plate of the truck is “IJKL”, which is both the masked version of the number plate “ABCD”. Only with the mapping table, one can obtain the actual number plate.

In an aspect, the provided method can trace cargo related data 200 at least at several access levels regarding display of information of cargo related data 200 to a user. The tracing step of data is indicated with reference numeral 400 in the flow chart shown in FIG. 1. Due to improved tracing of data, also security of data can be improved. The tracing 400 includes monitoring of access and display to cargo related data 200 preferably in very small time steps, so that access can be traced back preferably in a seamless way. Also, part of the tracing is to restrict access to cargo related data 200, e.g. by disabling media captures such as print outs and screenshots, and to provide viewing cargo related data 200 preferably only within the vehicle or predefined non-movable displays (even for debugging). An additional measure is to encrypt cargo related data 200 in regular intervals, e.g. daily. This can be done in various ways and is preferably done by using randomized keys, which are only available within an authorized network. By providing an encryption, cargo related data 200 is useless for external persons (having no access to the system where the cargo related data 200 can be displayed), since they cannot decrypt the information.

In an aspect, the method provides a periodic testing 500 of the accessibility and security of the cargo and/or fleet management system 100 by trying to extract cargo related data 200, which shall be excluded from being extracted. The testing step is indicated with reference numeral 500 in the flow chart shown in FIG. 1. For testing, preferably a (rudimentary) AI (artificial intelligence) based algorithm can be used to identify whether the cargo and/or fleet management system 100 has system gaps regarding access and security. For example, such gaps can be that ex-employees still have access with their password, since it has not been locked, or maintenance personnel or developers leave tools for debugging or other tasks accessible. Such issues can be found by regularly testing accessibility and security e.g. with simulating different scenarios of possible gaps in the cargo and/or fleet management system 100.

The described method is implemented as a computer program product, which is preferably executed on one or more processing units such as a computer terminal (calculation unit) associated with the cargo and/or fleet management system 100, i.e. being part of it or being in signal communication with it.

Due to the anonymization of cargo related data 200, data leakage is reduced, and valuable information is not unnecessarily available. Hence, prevention of cargo theft can be realized in an improved way. Also, improvement of traceability of access and display of important cargo relevant information is provided, so that theft can be detected and thieves be identified. By regularly maintaining and testing procedures, sink holes of data leakage can be detected, identified and closed. Also, the method being implemented with a software program product can be implemented without excessive costs and effort.

While subject matter of the present disclosure has been illustrated and described in detail in the drawings and foregoing description, such illustration and description are to be considered illustrative or exemplary and not restrictive. Any statement made herein characterizing the invention is also to be considered illustrative or exemplary and not restrictive as the invention is defined by the claims. It will be understood that changes and modifications may be made, by those of ordinary skill in the art, within the scope of the following claims, which may include any combination of features from different embodiments described above.

The terms used in the claims should be construed to have the broadest reasonable interpretation consistent with the foregoing description. For example, the use of the article “a” or “the” in introducing an element should not be interpreted as being exclusive of a plurality of elements. Likewise, the recitation of “or” should be interpreted as being inclusive, such that the recitation of “A or B” is not exclusive of “A and B,” unless it is clear from the context or the foregoing description that only one of A and B is intended. Further, the recitation of “at least one of A, B and C” should be interpreted as one or more of a group of elements consisting of A, B and C, and should not be interpreted as requiring at least one of each of the listed elements A, B and C, regardless of whether A, B and C are related as categories or otherwise. Moreover, the recitation of “A, B and/or C” or “at least one of A, B or C” should be interpreted as including any singular entity from the listed elements, e.g., A, any subset from the listed elements, e.g., A and B, or the entire list of elements A, B and C.

### REFERENCE NUMERALS

100 cargo and/or fleet management system
200 cargo related data
300 anonymization of data 200
301 Driver
302 Dispatcher
303 Supervisor
400 tracing of 200
500 testing of 100
CP Checkpoint
S1-S4 different steps of a process for route anonymization

1. A method for reducing thefts of cargo from commercial vehicles, comprising anonymizing cargo related data being used in a cargo and/or fleet management system is anonymized at least at several access levels in which the cargo related data is displayed to a user.

2. The method according to claim 1, wherein the anonymizing of the cargo related data includes masking of the cargo related data, including at least cargo type, cargo details, customer details, entire route from start to destination, and/or destination of the cargo.

3. The method according to claim 2, wherein masking of the entire route and/or masking of the destination of cargo includes providing checkpoints for each cargo route such that only a predefined part of the route is displayed at a time, and wherein a next checkpoint is displayed only after reaching a current checkpoint.

4. The method according to claim 3, wherein one of the checkpoints is the destination, and wherein:
the checkpoint that is the destination is only revealed a predefined number of checkpoints ahead of the destination, or
the checkpoint that is the destination is a last checkpoint.

5. The method according to claim 1, comprising tracing the cargo related data being used in a cargo and/or fleet management system at least at a plurality of levels of access.

6. The method according to claim 5, wherein the tracing and the display of the cargo related data includes at least:
tracing each access to the cargo related data in predefined time steps, and/or
restricting access to the cargo related data, and/or
encoding data transfers within the cargo and/or fleet management system.

7. The method according to claim 6, comprising disabling media captures and data export.

8. The method according to claim 1, comprising performing periodic testing by system wide tests configured to extract the cargo related data from the cargo and/or fleet management system in order to find a system gap, wherein the cargo related data is configured to be excluded from being extracted.

9. A non-transitory computer-readable medium having processor-executable instructions stored thereon, wherein the processor-executable instructions, when executed by one or more processors, facilitate performance of the method of claim 1.
